(19) United States
(12) Patent Application Publication
(10) Pub. No.: US 2024/0288725 A1
(43) Pub. Date: Aug. 29, 2024

(54) DISPLAY MODULE AND SPLICING DISPLAY SCREEN

(71) Applicant: HKC CORPORATION LIMITED, Shenzhen (CN)

(72) Inventors: Xiaogang HU, Shenzhen (CN); Baohong KANG, Shenzhen (CN)

(73) Assignee: HKC CORPORATION LIMITED, Shenzhen (CN)

(21) Appl. No.: 18/348,610

(22) Filed: Jul. 7, 2023

(30) Foreign Application Priority Data
Feb. 27, 2023 (CN) 202310217012.9

(51) Int. Cl. G02F 1/1333; G02F 1/1335; G02F 1/13357; G02F 1/1362; G02F 1/1368

(52) U.S. Cl. CPC G02F 1/13336; G02F 1/133314; G02F 1/13332; G02F 1/133512; G02F 1/1336; G02F 1/136222; G02F 1/1368

(57) ABSTRACT

A display module and a splicing display screen, which relate to the field of display technology. The display module includes a middle frame, an optical film sheet, a lower polarizer, an LCD panel and an upper polarizer arranged from bottom to top; the LCD panel includes a color film substrate and an array substrate, side frame glues are provided at the flush side walls of the color film substrate and the array substrate, and no front frame is provided on the upper surface of the upper polarizer; and the lower polarizer is adhered to the middle frame through a back frame glue. The solutions provided may reduce the width of the non-display area at the splices of the display modules and improve the display effect.

### CROSS-REFERENCE TO RELATED APPLICATIONS

This application claims the benefit of Chinese Patent Application No. 202310217012.9, entitled DISPLAY MODULE AND SPLICING DISPLAY SCREEN, which was filed with China National Intellectual Property Administration on Feb. 27, 2023, and the entire contents of which are incorporated herein by reference.

### TECHNICAL FIELD

The present disclosure relates to the field of display technology, in particular to a display module and a splicing display screen.

### BACKGROUND

With the wide application of display screens in people's daily life, the demand for various extra-large display screens is increasing day by day. Currently, splicing multiple display modules is the mainstream way to obtain an extra-large display screen.

However, in case where multiple display modules are spliced to form a large display screen to display, the non-display area at the splices of the large display screen is relatively obvious due to the gaps at the splices, which affects the overall display effect. Therefore, how to reduce the width of the non-display area at the splices of the display modules is a problem that technicians in this field need to solve.

### SUMMARY

In view of the above, this disclosure provides a display module and a splicing display screen, to reduce the width of the non-display area at the splices of the display modules and improve the display effect.

To this end, a first aspect of the embodiments of this disclosure provides a display module, which is applicable to a splicing display screen and includes a middle frame, an optical film sheet and an LCD panel;
the middle frame includes a bottom frame and a side frame arranged around the bottom frame, the optical film sheet is positioned above the bottom frame, the LCD panel is positioned above the side frame and the optical film sheet, and the LCD panel is adhered to the side frame; and
an even side of the LCD panel is adhered to a first light blocking unit through a frame glue, and no blocking part is provided at a side of the LCD panel facing away from the optical film sheet.

As an optional implementation, the first light blocking unit includes a first front frame which at least covers the even side of the LCD panel.

As an optional implementation, an upper surface of the first front frame is flush with an upper surface of the LCD panel, the lower surface of the first front frame is flush with and lower surface of the LCD panel, and the lower surface of the first front frame is adhered to an upper surface of the side frame through the frame glue.

As an optional implementation, an outer side of the first front frame is covered with a light blocking film, which extends downward to cover the side frame.

As an optional implementation, the first light blocking unit comprises the first light blocking film, which extends downward to cover the side frame.

As an optional implementation, a second light blocking unit is provided at an Outer Lead Bonding side of the LCD panel, the LCD panel includes a color film substrate and an array substrate, an upper surface of a projection part of the array substrate relative to the color film substrate is cover with a Chip on Film film, and above the Chip on Film film, a region between the second light blocking unit and the color film substrate is filled with a curing adhesive.

As an optional implementation, the second light blocking unit includes a second front frame, which extends downward to cover the side frame.

As an optional implementation, the second light blocking unit includes a second light blocking film, which extends downward to cover the side frame.

As an optional implementation, the display module further includes a backlight substrate, which is positioned beneath the middle frame and comprises a plurality of lamps.

A second aspect of the embodiments of this disclosure provides a splicing display screen, which includes a plurality of display modules according to the first aspect or any one of the first aspect, and the plurality of display modules are spliced to form the splicing display screen.

The display module and the splicing display screen provided in the embodiments of this disclosure include a middle frame, an optical film sheet and an LCD panel; the middle frame includes a bottom frame and a side frame arranged around the bottom frame, the optical film sheet is positioned above the bottom frame, the LCD panel is positioned above the side frame and the optical film sheet, and the LCD panel is adhered to the side frame; an even side of the LCD panel is adhered to a first light blocking unit through a frame glue, and no blocking part is provided at the side of the LCD panel facing away from the optical film sheet. In the above technical solution, no blocking part is provided at the side of the LCD panel facing away from the optical film sheet. Compared with the existing splicing display screens in which the upper end of the front frame is bent inward (the inward bent front frame will block part of the display area of the LCD panel), the technical solution of this disclosure may allow the blocked display area of the LCD panel to display and reduce the width of the non-display area on the edges of the display module, thus reduce the width of the non-display area (including the splice seam and the non-display area at the edges of the two display modules on both sides of the splice seam) at the splices of the display module and other display module(s), and improve the overall display effect. In addition, the even side of the LCD panel is adhered to the first light blocking unit through the frame glue, which may prevent water vapor, dust, etc. from entering the LCD panel, and also reduce the leakage of PI solution in the LCD panel, so that the technical solution may further improve the display effect. At the same time, the LCD panel is adhered to the side frame, so that the LCD panel may be secured without the LCD panel being blocked by a bent part of the front frame, so that the LCD panel will not fall off.

### BRIEF DESCRIPTION OF THE DRAWINGS

FIG. 1 is a partial schematic structure diagram of any display module in the ultra-large display screen provided in one embodiment of this disclosure;

FIG. 2 is a schematic structure diagram of a display module provided in another embodiment of this disclosure;

FIG. 3 is a schematic structure diagram of a splicing display screen provided in one embodiment of this disclosure;

FIG. 4 is a schematic structure diagram of a splicing display screen provided in another embodiment of this disclosure;

FIG. 5 is a schematic structure diagram of a display module provided in a further embodiment of this disclosure;

FIG. 6 is a schematic structure diagram of a light blocking film shown in FIG. 5.

### DETAILED DESCRIPTION OF THE EMBODIMENTS

Embodiments of the present disclosure are described below in connection with the accompanying drawings in the embodiments of the present disclosure. The terms used in the implementations of the embodiments of this disclosure are used only for the purpose of explaining the specific embodiments of this disclosure and are not intended to limit this disclosure. The following specific embodiments may be combined with each other, and the same or similar concepts or processes may not be repeated in some embodiments.

With the increasing demand for various ultra-large display screens, the ultra-large screen is currently mainly realized by splicing multiple display modules. To better display effect, the size of a non-display area at a splice of the ultra-large display screen is getting narrower and narrower, from 3.8 mm to 3.5 mm to 2.8 mm. In this case, the non-display area at the splice of the ultra-large display screen may include the splice seam and the non-display area at the edges of two display modules on both sides of the splice seam.

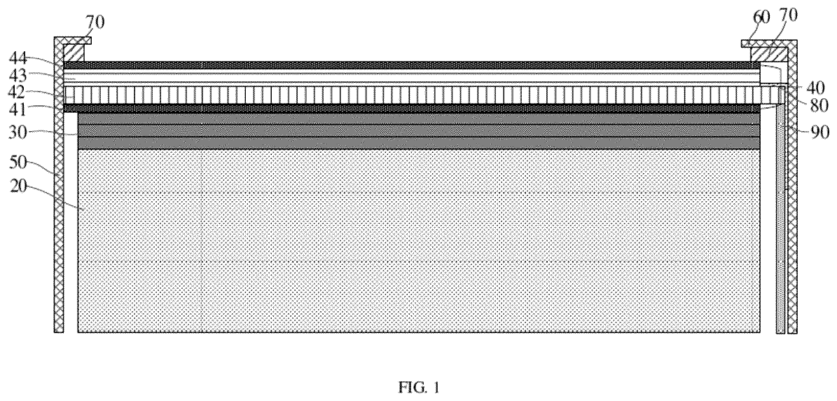

FIG. 1 is a partial schematic structure diagram of any display module of the ultra-large display screen provided in one embodiment of this disclosure. As shown in FIG. 1, the display module may include a middle frame 20, an optical film sheet 30, and an LCD panel 40 arranged successively from bottom to top.

The LCD panel 40 may include a lower polarizer 41, an array substrate 42, a color film substrate 43, and an upper polarizer 44 arranged from bottom to top.

A first front frame 50 and a second front frame 60 may be arranged at the outer side of the LCD panel 40 for blocking light.

The upper surfaces of the first front frame 50 and the second front frame 60 are bent inward to limit the LCD panel, and prevent the LCD panel 40 from falling off.

Rubber units (ruber) 70 may be arranged between the bending regions of the first front frame 50 and the second front frame 60 and the upper polarizer 44 for cushioning.

The upper surface of the projecting part of the array substrate 42 relative to the color film substrate 43 may be covered with a COF (Chip on Film) film 80. Further, a PCB (Printed Circuit Board) 90 may be arranged between the middle frame 20 and the second front frame 60, and the PCB 90 may be connected with the array substrate 42 through a bonded COF 80. Because the COF 80 bonded on the right side of the LCD panel 40 has a certain width, the width of the non-display area on the left side of the display module increases, and is larger than the width of the non-display area on the right side.

However, the bending regions at the upper ends of the first front frame 50 and the second front frame 60 have blocked part of the display area of the LCD panel 40, which makes the blocked part of the display area cannot display normally, resulting in an increased width of the non-display area at the splice of the ultra-large display screen and affecting the overall display effect.

In view of this, the embodiments of this disclosure provide a display module to reduce the width of the non-display area at the splice of the display modules and improve the overall display effect.

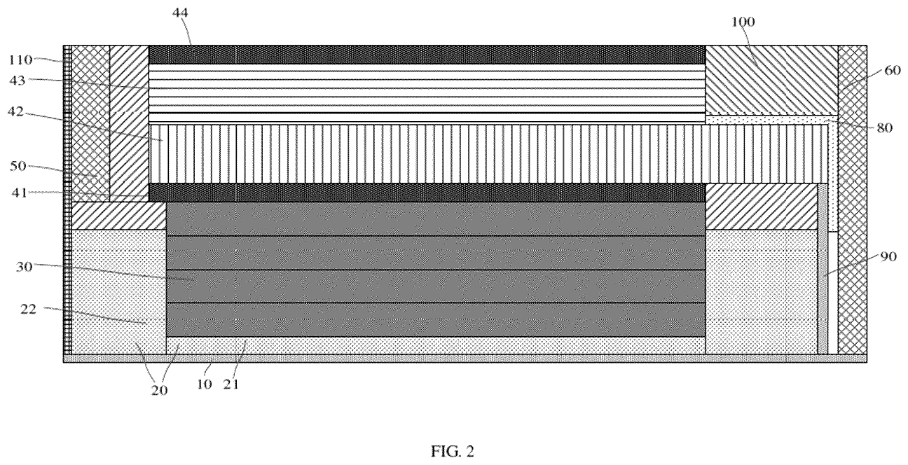

FIG. 2 is a schematic structure diagram of the display module provided in another embodiment of this application. As shown in FIG. 2, the display module provided in this embodiment may include: a middle frame, an optical film sheet and an LCD panel.

The middle frame includes a bottom frame 21 and a side frame 22 arranged around the bottom frame 21, the optical film sheet is positioned above the bottom frame 21, the LCD panel is positioned above the side frame 22 and the optical film sheet, and the LCD panel is adhered to the side frame 22. In this way, the LCD panel 40 may be secured and the probability of the LCD panel 40 falling off may be reduced.

The LCD panel may be adhered to the side frame 22 through a frame glue, or through other adhesives. In this embodiment, an exemplary illustration is provided by taking the LCD panel adhered to the side frame 22 through the frame glue as example. The thickness of the frame glue may be 0.1˜0.5 mm.

The frame glue is mainly prepared from epoxy resin, curing agent, filler and other additives.

An even side of the LCD panel is adhered to a first light blocking unit through the frame glue, which may prevent water vapor, dust, etc. from entering the LCD panel 40, and may also reduce the leakage of PI solution in the LCD panel 40, so as to improve the display effect.

No blocking part is provided at the side of the LCD panel facing away from the optical film sheet, so that the blocked display area at the edge of the LCD panel 40 may display normally. Therefore, the width of the non-display area at the edge of the display module may be reduced, and further the width of the non-display area at the splice of the display module and another display module may be reduced, and the overall display effect may be improved.

The blocking part may be the inwardly bending part of the top of the front frame, or may be the ruber or other structure, which is not specified in this embodiment.

The LCD panel may include a lower polarizer 41, an array substrate 42, a color film substrate 43 and an upper polarizer 44 arranged from bottom to top.

The first light blocking unit may be the first front frame 50 (the front end of the first front frame 50 is not bent inward).

The upper surface of the first front frame 50 may be flush with the upper surface of the upper polarizer 44 to enhance the overall appearance. The first front frame 50 may extend downward to cover the outer wall of the middle frame 20. For convenience of transportation and assembly, the lower surface of the first front frame 50 may be flush with the lower surface of lower polarizer 41. In this case, the lower surface of the first front frame 50 may be adhered to the upper surface of the side frame 22 through a frame glue. Later the embodiment will provide exemplary illustration by taking the lower surface of the first front frame 50 being flush with the lower surface of the lower polarizer 41 as example.

The thickness of the first front frame 50 may be greater than or equal to 0.2 mm and less than or equal to 0.5 mm, so that the thickness of the first front frame 50 is not so small that the first front frame 50 would break, or so large that the first front frame 50 would affect the width of the non-display area at the splice of the display module and another display module.

The outer side of the first front frame 50 may be covered with a light blocking film 110 to ensure the overall appearance and reduce the light leakage at the corresponding edge of the display module. The light blocking film 110 may be specifically polyester film and a film formed by combining polyester with other compounds.

The light blocking film 110 may also extend downward to cover the outer wall of side frame 22 to further reduce the light leakage at the corresponding edge of the display module.

A second light blocking unit may be provided at the OLB (Outer Lead Bonding) side of the LCD panel 40. The second light blocking unit may be the second front frame 60, so as to further stabilize the LCD panel 40. Since the upper ends of the first front frame 50 and the second front frame 60 are not bent, the thickness of the display module (that is, the part of the front frames beyond the upper surface of the upper polarizer 44) may be reduced and the thickness of the display screen may be reduced.

The upper surface of the projecting part of the array substrate 42 relative to the color film substrate 43 may be covered with a COF film 80. Above the COF film 80, the region between the second front frame and the color film substrate 43 may be filled with a curing adhesive.

The curing adhesive 100 may be black and other opaque color for blocking the scattered light. The thickness of the curing adhesive 100 may be greater than or equal to 0.3 mm and less than or equal to 0.5 mm to ensure the overall appearance.

The curing adhesive 100 may be UV (Ultraviolet Rays) adhesive, silicone, RUR (Polyurethane Reactive) adhesive, etc.

A PCB 90 may also be arranged between the side frame 22 and the second front frame 60. The PCB 90 may be connected to the array substrate 42 through the COF 80. A driver chip may be provided on the PCB 90 for driving the LCD panel 40.

The two sides of the optical film sheet 30 may be flush with the two sides of the LCD panel 40. Since non-display area exists at the edges on both sides of the LCD panel 40, the width of the optical film sheet 30 may also be narrower than the width of the LCD panel 40, to cover only the display area of the LCD panel 40. That is, the projection region of optical film sheet 30 on the backlight substrate 10 may be located within the projection region of color film substrate 43 on the backlight substrate 10. In this embodiment, an exemplary illustration is provided by taking the optical film sheet 30 covering only the display area of the LCD panel 40 as example.

The display module may further include a backlight substrate 10 positioned beneath the middle frame 20. The backlight substrate 10 may include a plurality of lamps for providing a light source for the display module.

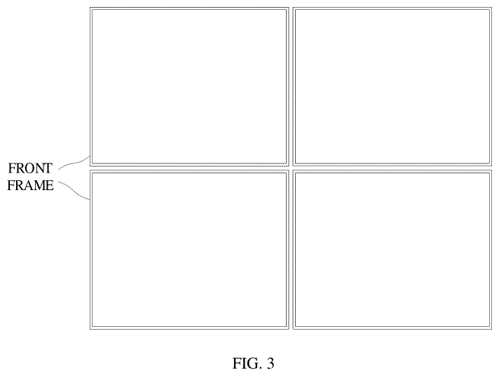

FIG. 3 is a schematic structure diagram of a splicing display screen provided in one embodiment of this disclosure. As shown in FIG. 3, the splicing display screen provided in the embodiment of this disclosure may include 4 display modules in the above embodiments. The 4 display modules are spliced to form the splicing display screen. The front frames may be arranged around each display module to make the LCD panels 40 more stable.

It is understood that the splicing display screen provided in the embodiment of this disclosure may include more or less than 4 display modules. An exemplary illustration is provided herein by taking a splicing display screen including 4 spliced display modules as example.

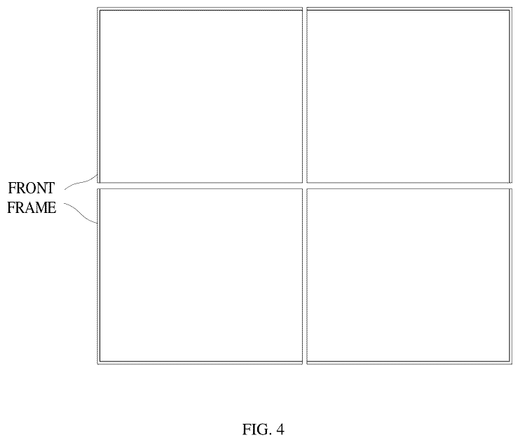

FIG. 4 is a schematic structure diagram of a splicing display screen provided in another embodiment of this disclosure. As shown in FIG. 4, it is also possible to arrange a front frame only around the periphery of the splicing display screen (that is, no front frame is arranged in the area corresponding to the splice of each display module). In this way, by reducing the front frames corresponding to the splices, not only the width of the non-display area at the edges of each display modules may be further reduced and the width of the non-display area at the splice of the display module and other display modules may be reduced, but also the cost may be saved.

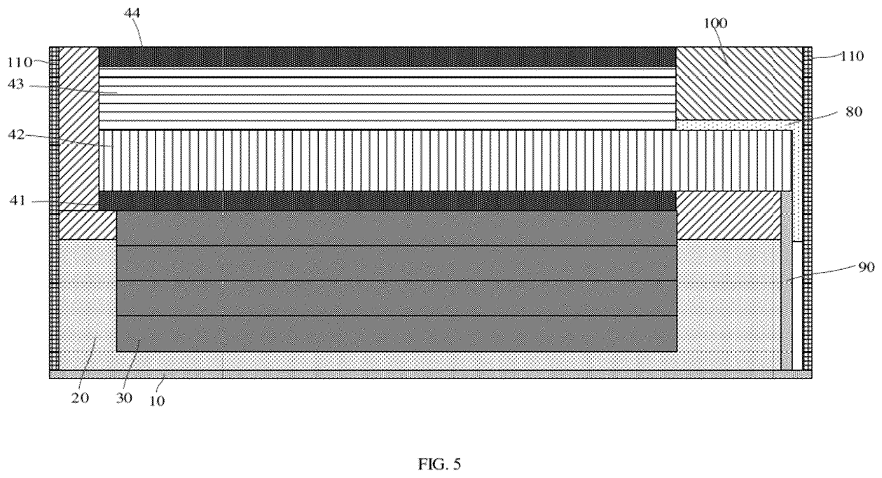

FIG. 5 is a schematic structure diagram of a display module provided in a further embodiment of this disclosure. As shown in FIG. 5, the first front frame 50 and the second front frame 60 outside of the display module may also be removed, so that the width of the non-display area at the edge of the display module may become narrower, thus achieving the purpose of reducing the width of the non-display area at the splices of the display module and other display modules.

After removing the first front frame 50 and the second front frame 60 of the display module, a light blocking film 110 (equivalent to the first light blocking unit) may be adhered to the even side of the LCD panel through the frame glue, and a light blocking film 110 (equivalent to the second light blocking unit) may be arranged at the OLB side of the LCD panel 40 and extend downward to cover the outer wall of the middle frame 20. This may ensure the overall appearance, and may reduce the probability of light leakage at the edge of the display module.

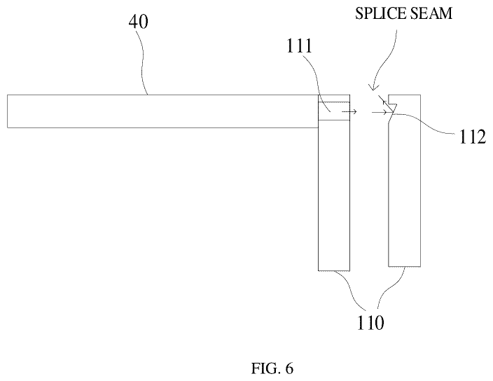

FIG. 6 is a schematic structure diagram of the light blocking film shown in FIG. 5. As shown in FIG. 6, a light transmitting part 111 may be provided where the light blocking film 110 on one side of the splice seam corresponds to the LCD panel 40, and a reflecting part 112 may be provided where the light blocking film 110 on the other side of the splice seam corresponds to the light transmitting part 111. The reflecting part 112 may be an obtriangular inward concave. The light emitted by the LCD panel 40 may pass through the light transmitting part 111 to be irradiated on the reflecting part 112, and the light is reflected out of the splice seam by the reflecting part 112. This may improve the brightness at the splice seam, so that the brightness at the splice seam and the brightness at the display area of the display module tend to be consistent, thus improving the uniformity of the display brightness.

The display module and the splicing display screen provided in the embodiments of this disclosure include a middle frame, an optical film sheet and an LCD panel; the middle frame includes a bottom frame and a side frame arranged around the bottom frame, the optical film sheet is positioned above the bottom frame, the LCD panel is positioned above the side frame and the optical film sheet, and the LCD panel is adhered to the side frame; an even side of the LCD panel is adhered to a first light blocking unit through a frame glue, and no blocking part is provided at the side of the LCD panel facing away from the optical film sheet. In the above technical solution, no blocking part is provided at the side of the LCD panel facing away from the optical film sheet. Compared with the existing splicing display screens in which the upper end of the front frame is bent inward (the inward bent front frame will block part of the display area of the LCD panel), the technical solution of this disclosure may allow the blocked display area of the LCD panel to display and reduce the width of the non-display area on the edges of the display module, thus reduce the width of the non-display area (including the splice seam and the non-display area at the edges of the two display modules on both sides of the splice seam) at the splices of the display module and other display module(s), and improve the overall display effect. In addition, the even side of the LCD panel is adhered to the first light blocking unit through the frame glue, which may prevent water vapor, dust, etc. from entering the LCD panel, and also reduce the leakage of PI solution in the LCD panel, so that the technical solutions may further improve the display effect. At the same time, the LCD panel is adhered to the side frame, so that the LCD panel may be secured without the LCD panel being blocked by a bent part of the front frame, so that the LCD panel will not fall off.

In the above embodiments, the description of each embodiment has its own emphasis. For part of the embodiments that is not described in detail or recited, related description of other embodiments may be referred to.

In addition, the dimensional scale relationship between the components in the attached drawings is only illustrative and does not reflect the actual dimensional scale relationship between the components.

In the description of this disclosure, the orientation or positional relationship indicated by the terms “center”, “longitudinal”, “lateral”, “upper”, “lower”, “front”, “back”, “left”, “right”, “vertical”, “horizontal”, “top”, “bottom”, “inside”, “outside”, etc. are based on the orientation or positional relationship shown in the attached drawings, which are intended only to facilitate and simplify the description of the invention, not to indicate or imply that the equipment or components referred to must have a particular orientation, be constructed and operate in a particular orientation, and therefore are not to be construed as limiting the invention.

In the description of this disclosure, it should be noted that, unless otherwise expressly specified and limited, the terms “mounted”, “connected”, “connection” are to be understood in a broad sense. For example, it can be a fixed connection, a detachable connection, or a one-piece connection; it can be a mechanical connection or an electrical connection; it can be a direct connection or an indirect connection through an intermediate medium, and it can be a connection within two components. For those skilled in the art, the specific meaning of the above terms in the context of the present invention can be understood according to specific situations.

It should be understood that, when used in the specification and the accompanying claims of this disclosure, the term “include” indicates the existence of the described features, whole, steps, operations, elements and/or components, but does not preclude the existence or addition of one or more other features, whole, steps, operations, elements, components and/or a group thereof.

In the description of this disclosure, unless otherwise stated, “/” indicates that the associated objects before and after it are in an “or” relationship, for example, A/B may mean either A or B. The “and/or” in this disclosure is only an association relationship describing the associated objects, indicating that there may be three kinds of relationships, for example, A and/or B, may mean: A alone, A and B simultaneously, B alone, where A and B can be singular or plural.

In addition, in the description of this disclosure, “multiple” means two or more than two, unless otherwise stated. “At least one of the following”, or similar expressions thereof, means any combination of these items, including any combination of singular or plural items. For example, at least one of a, b, or c, may represent: a, b, c, a-b, a-c, b-c, or a-b-c, where a, b, c may be singular or plural.

In addition, in the description of the specification and the accompanying claims of this disclosure, the terms “first”, “second”, “third”, etc. are used to distinguish similar objects, and need not be used to describe a particular order or sequence. It is understood that the data used in this way may be interchanged where appropriate, so that the embodiments described herein can be implemented in an order other than that illustrated or described herein.

References to “one embodiment” or “some embodiments” as described in the specification of this disclosure, etc., imply that one or more embodiments of this disclosure include particular features, structures or characteristics described in conjunction with such embodiments. Thus, the statements “in one embodiment”, “in some embodiments”, “in some other embodiments”, “in some further embodiments”, etc. which appear at different positions in this specification do not necessarily all refer to the same embodiments, but mean “one or more but not all embodiments”, unless otherwise specifically emphasized.

Finally, it should be noted that, the above embodiments are merely intended for describing but not for limiting the technical solutions of the present disclosure. Although the present disclosure is described in detail with reference to the above-mentioned embodiments, it should be understood by those skilled in the art that, the technical solutions recited in each of the above-mentioned embodiments may still be modified, or some of or all the technical features may be equivalently replaced, while these modifications or replacements do not make the essence of the corresponding technical solutions depart from the scope of the technical solutions of each of the embodiments of the present disclosure.

What is claimed is:

1. A display module applicable to a splicing display screen, comprising: a middle frame, an optical film sheet and an LCD panel;
wherein the middle frame comprises a bottom frame and a side frame arranged around the bottom frame, the optical film sheet is positioned above the bottom frame, the LCD panel is positioned above the side frame and the optical film sheet, and the LCD panel is adhered to the side frame; and
an even side of the LCD panel is adhered to a first light blocking unit through a frame glue, and no blocking part is provided at a side of the LCD panel facing away from the optical film sheet.

2. The display module according to claim 1, wherein the first light blocking unit comprises a first front frame which at least covers the even side of the LCD panel.

3. The display module according to claim 2, wherein an upper surface of the first front frame is flush with an upper surface of the LCD panel, the lower surface of the first front frame is flush with and lower surface of the LCD panel, and the lower surface of the first front frame is adhered to an upper surface of the side frame through the frame glue.

4. The display module according to claim 2, wherein an outer side of the first front frame is covered with a light blocking film which extends downward to cover the side frame.

5. The display module according to claim 1, wherein the first light blocking unit comprises a first light blocking film which extends downward to cover the side frame.

6. The display module according to claim 1, wherein a second light blocking unit is provided at an outer lead bonding side of the LCD panel, the LCD panel comprises a color film substrate and an array substrate, an upper surface of a projection part of the array substrate relative to the color film substrate is cover with a Chip on Film film, and above the Chip on Film film, a region between the second light blocking unit and the color film substrate is filled with a curing adhesive.

7. The display module according to claim 6, wherein the second light blocking unit comprises a second front frame which extends downward to cover the side frame.

8. The display module according to claim 6, wherein the second light blocking unit comprises a second light blocking film which extends downward to cover the side frame.

9. The display module according to claim 1, wherein the display module further comprises a backlight substrate which is positioned beneath the middle frame and comprises a plurality of lamps.

10. The display module according to claim 2, wherein the display module further comprises a backlight substrate which is positioned beneath the middle frame and comprises a plurality of lamps.

11. A splicing display screen, comprising: a plurality of display modules, wherein the plurality of display modules are spliced to form the splicing display screen, and each of the plurality of display modules comprises a middle frame, an optical film sheet and an LCD panel;
wherein the middle frame comprises a bottom frame and a side frame arranged around the bottom frame, the optical film sheet is positioned above the bottom frame, the LCD panel is positioned above the side frame and the optical film sheet, and the LCD panel is adhered to the side frame; and
an even side of the LCD panel is adhered to a first light blocking unit through a frame glue, and no blocking part is provided at a side of the LCD panel facing away from the optical film sheet.

12. The splicing display screen according to claim 11, wherein the first light blocking unit comprises a first front frame which at least covers the even side of the LCD panel.

13. The splicing display screen according to claim 12, wherein an upper surface of the first front frame is flush with an upper surface of the LCD panel, the lower surface of the first front frame is flush with and lower surface of the LCD panel, and the lower surface of the first front frame is adhered to an upper surface of the side frame through the frame glue.

14. The splicing display screen according to claim 12, wherein an outer side of the first front frame is covered with a light blocking film which extends downward to cover the side frame.

15. The splicing display screen according to claim 11, wherein the first light blocking unit comprises a first light blocking film which extends downward to cover the side frame.

16. The splicing display screen according to claim 11, wherein a second light blocking unit is provided at an outer lead bonding side of the LCD panel, the LCD panel comprises a color film substrate and an array substrate, an upper surface of a projection part of the array substrate relative to the color film substrate is cover with a Chip on Film film, and above the Chip on Film film, a region between the second light blocking unit and the color film substrate is filled with a curing adhesive.

17. The splicing display screen according to claim 16, wherein the second light blocking unit comprises a second front frame which extends downward to cover the side frame.

18. The splicing display screen according to claim 16, wherein the second light blocking unit comprises a second light blocking film which extends downward to cover the side frame.

19. The splicing display screen according to claim 11, wherein the display module further comprises a backlight substrate which is positioned beneath the middle frame and comprises a plurality of lamps.

20. The splicing display screen according to claim 12, wherein the display module further comprises a backlight substrate which is positioned beneath the middle frame and comprises a plurality of lamps.
